(19) United States
(12) Patent Application Publication
(10) Pub. No.: US 2008/0110816 A1
(43) Pub. Date: May 15, 2008

(54) Filter cartridge containing reticulated foam fluid treatment media

(75) Inventors: David Leavitt, Edmond, OK (US); John Famula, Severna Park, MD (US); Christer Broman, Millersville, MD (US); Jeremy Hess, Fayetteville, AR (US); Elmo Geppelt, Tulsa, OK (US)

Correspondence Address: DUNLAP CODDING & ROGERS, P.C., PO BOX 16370, OKLAHOMA CITY, OK, 73113, US

(73) Assignee: Fluid Treatment Systems, Inc.

(21) Appl. No.: 11/599,060

(22) Filed: Nov. 14, 2006

(51) Int. Cl. C02F 1/70; C02F 1/72

(52) U.S. Cl. 210/266; 210/202; 210/501

(57) ABSTRACT

A filter assembly is operably connected to a supporting structure. The filter assembly removes contaminants from a fluid. The filter assembly includes a filter housing, a filter cartridge, and a reticulated foam fluid treatment media. The filter housing has an inlet, an outlet and a chamber extending through the filter housing. The filter cartridge is positioned in the chamber of the filter housing. The filter cartridge is constructed from a fibrous material used to filter contaminants from a fluid. The filter cartridge has a passageway extending from a proximal end of the filter cartridge to a distal end of the filter cartridge. The reticulated foam fluid treatment media is disposed within a portion of the passageway of the filter cartridge.

### CROSS-REFERENCE TO RELATED APPLICATIONS

Not applicable.

### BACKGROUND OF THE INVENTION

1. Field of the Invention

The present invention relates generally to fluid treatment systems and more particularly, but not by way of limitation, to a filter cartridge containing reticulated foam fluid treatment media.

2. Description of the Related Art

Fluid treatment, especially for water is often needed for drinking, bathing, cooking and general household, industrial, military and medical applications. Such fluid treatment desirably includes removing or reducing undesirable biological and/or chemical entities, for neutralizing and counter-acting or harmful effects of such undesired biological and/or chemical entities.

Numerous methods for treating fluids, such as water to remove undesired biological and/or chemical entities have heretofore been proposed and employed, such as treatment of the water with chlorine, filtration, reverse osmosis, activated carbon and ion exchange.

Fluid treatment media of such treatment systems are complex and expensive. Thus, more simple systems of filtration have often been employed, especially when treating fluid for household use including the treatment of the water of swimming pools and spas. In addition to removing undesired biological and/or chemical entities from such water, it is also desirable to remove heavy metals from the water. Metals that may be present in such water includes copper, chromium, zinc, cadmium, mercury, lead and nickel.

While various processes have herebefore been proposed to remove such heavy metals by chemical precipitation, new and improved methods for removing heavy metals, as well as undesirable biological and/or chemical entities are desired. Thus, a need remains for new and effective treatment methods for water and other liquids, particularly for methods and devices that can effectively remove bacteria, undesirable chemicals and heavy metals from the water supply, especially when utilizing such water in swimming pools and spas.

### SUMMARY OF THE INVENTION

According to the present invention, a filter cartridge containing a reticulated foam fluid treatment media is provided for treating fluids, such as water. Broadly, the reticulated foam fluid treatment media of the filter cartridge employed in the practice of the present invention can be (a) a substantially flexible reticulated foam fluid treatment media wherein a particle layer bound to surface of a porous flexible substrate can be varied in composition so that the flexible reticulated foam fluid treatment media is capable of promoting a wide variety of fluid treatment functions including oxidation/reduction reactions, catalytic reactions and chemical absorption of contaminants; (b) a substantially rigid reticulated foam fluid treatment media wherein the particles are bound together in an interconnected form of a porous metal, sponge-like structure; and (c) combinations thereof. The particles employed in the fabrication of the substantially flexible reticulated foam fluid treatment media and the substantially rigid reticulated foam fluid treatment media can vary widely depending upon the intended use of such media.

In one aspect, a filter cartridge is provided having a reticulated foam fluid treatment media disposed within at least a portion of a central passageway of the filter cartridge. If required, the reticulated foam fluid treatment media can be stabilized within the passageway of the filter cartridge with a piece of porous material wrapped about at least a portion of the reticulated foam fluid treatment media so as to stabilize same within the passageway of the filter cartridge. When the filter cartridge is provided with a substantially flexible fluid treatment media, the filter cartridge may further be provided with a cartridge retainer member for stabilizing the substantially flexible fluid treatment media in the central passageway of the filter cartridge.

In still another aspect, a filter cartridge is provided which includes a reticulated foam fluid treatment media section embedded within the filter cartridge.

### BRIEF DESCRIPTION OF THE SEVERAL VIEWS OF THE DRAWINGS

FIG. 1 is a perspective view of a reticulated foam fluid treatment media constructed in accordance with the present invention.

FIG. 2 is a partial cross-sectional view of a filter housing containing a filter cartridge, the filter cartridge having the reticulated foam fluid treatment media of FIG. 1 disposed within a passageway of the filter cartridge.

FIG. 3 is a fragmental, partial cross-sectional view of the filter housing having a filter cartridge containing the reticulated foam fluid treatment media of FIG. 1 therein, the filter housing having a cartridge retainer disposed adjacent an outlet of the housing for stabilizing the reticulated foam fluid treatment media within the passageway of the filter cartridge.

FIG. 4 is a perspective view of the cartridge retainer of FIG. 3.

FIG. 5 is a fragmental, partial cross-sectional view of the filter housing having the filter cartridge containing the reticulated foam fluid treatment media of FIG. 3 wherein a piece of fluid permeable material is disposed about at least a portion of the reticulated foam fluid treatment media to stabilize same within the passageway of the filter cartridge.

FIG. 6 is an isometric, partially cut-away view of another embodiment of a filter cartridge constructed in accordance with the present invention wherein a reticulated foam fluid treatment media is embedded within the filter cartridge and forms a section thereof.

### DETAILED DESCRIPTION OF THE INVENTION

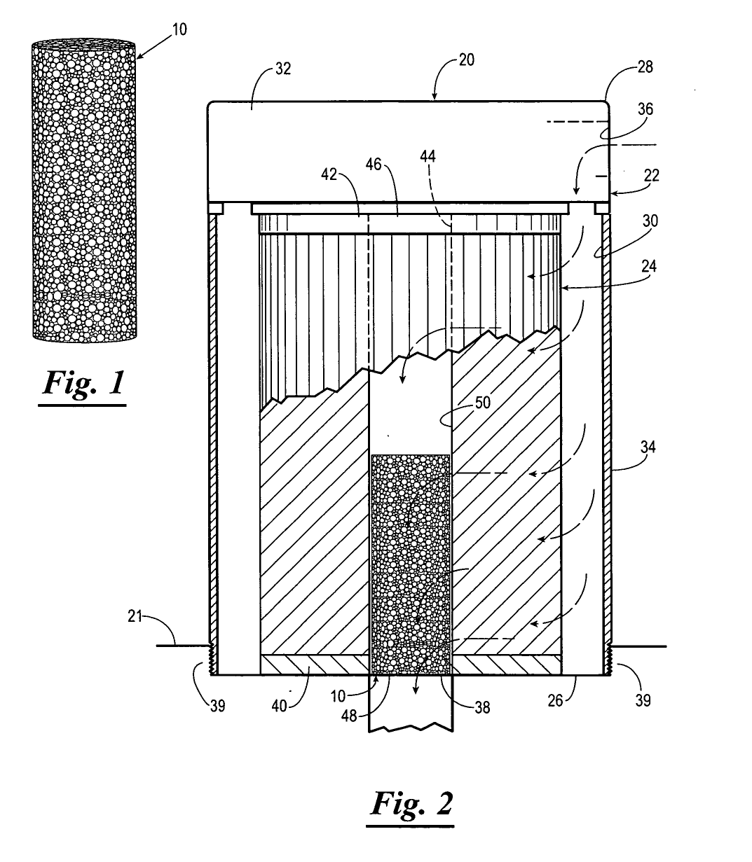

Referring now to the drawings, and more particularly to FIG. 1, shown therein is a reticulated foam fluid treatment media 10 constructed in accordance with the present invention. The reticulated foam fluid treatment media 10 can be (a) a flexible reticulated foam fluid treatment media which is capable of promoting a wide variety of fluid treatment functions including oxidation/reduction reactions, catalytic reactions and chemical absorption of contaminants in fluid to be treated; or, (b) a substantially rigid reticulated foam fluid treatment media which includes metal particles bound together in an interconnected form of a porous metal, sponge-like structure; or, (c) combinations of (a) and (b).

The flexible reticulated foam fluid treatment media 10 employed in combination with a filter cartridge includes a flexible porous substrate coated with a stable mixture of particles, including but not limited to, metal particles, metal oxide particles, activated carbon particles and mixtures thereof. The particular combination of particles will be dependent upon the particular contaminants present in the fluid to be treated utilizing the filter cartridge containing the flexible reticulated foam fluid treatment media 10. For example, when the flexible reticulated foam fluid treatment media 10 contains a mixture of activated carbon and copper/zinc metal particles, the media can be used to treat fluids by the synergistic action of absorption of contaminants onto the activated carbon and the catalyzed oxidation/reduction of contaminants by the copper/zinc metal particles.

In preparing the flexible reticulated foam fluid treatment media 10, a soft or flexible porous substrate is first coated with a binder. Thereafter, excess binder is removed from the coated substrate so that the substrate is provided with a substantially uniform binder layer on the surface of the substrate. The surface coated substrate is then allowed to dry to a tacky state and thereafter the surface coated substrate is coated with a plurality of particles selected from the group consisting of metal particles, metal oxide particles, activated carbon particles and mixtures thereof. The excess particles are removed and the coated substrate subjected to compressive forces whereby the flexible porous substrate is substantially impregnated with the binder and the particles. The compressed coated substrate is then cured by air drying using ambient air or heated air. Lastly, any excess particles lodged in the pores of the flexible reticulated foam fluid treatment media 10 are removed. It should be noted that during the curing phase the binder will continue to seep into the saturated particulate coating, forming a uniform, evenly distributed cured coating layer tightly and seamlessly bound to the surface of the substrate.

The compression of the coated substrate can be accomplished using any mechanical apparatus capable of pressing the binder into the pores and irregular surfaces of the substrate, thereby eliminating air pockets and insuring a strong, seamless and stable bond between the substrate and the binder. For example, compression of the coated reticulated foam substrate can be accomplished by passing the coated reticulated foam substrate through a gap formed between two rollers where the size of the gap, i.e. the distance between the rollers, is correlated to the amount of compressive force applied to the substrate. The gap is set by applying tension to the rollers so that a hill surface of one roller meshes with a valley surface of the other roller which assists in feeding the coated substrate through the rollers.

Adjusting the tension applied to the rollers controls the compressive force applied to the substrate. The amount of compressive force applied to the coated foam substrate is an important factor in the method of preparation of the flexible reticulated foam fluid treatment media 10 because too small applied force results in an unstable bond between the substrate, the binder and the particle materials and too great of an applied force damages the coated material and closes off the open pores and void spaces inherent in the flexible reticulated foam fluid treatment media 10, thereby reducing the porosity and surface area of the flexible reticulated foam fluid treatment media 10 and its effective use in fluid treatment.

The flexible foam substrate employed in the construction of the flexible reticulated foam fluid treatment media 10 can be fabricated of any flexible, porous material, such as polymeric or composite material that can provide the reticulated foam fluid treatment media 10 with the desired flexibility, stability, porosity and pore size. Examples of various flexible polymeric materials which can be employed as the flexible foam substrate include, but are not limited to, polyethylene, polyether, polypropylene, polyurethane, polyester, polystyrene, polycarbonate, copolymers of acrylic and non-acrylic polymers, blends thereof and the like.

The number of pores per square inch of the flexible foam substrate employed to produce the flexible reticulated foam fluid treatment media 10 can vary widely, however, desirable results have been obtained wherein the number of pores per square inch of the flexible foam substrate is from about 5 to about 30 pores per square inch. Similarly, the pore size of the pores in the flexible foam substrate can vary widely and will generally be from about 10 microns to about a quarter of an inch when one cubic inch of a flexible foam substrate has a surface area of at least 350 square inches. While any suitable polymeric or composite material having the before defined characteristics can be employed as the flexible foam substrate in the fabrication of the flexible reticulated foam fluid treatment media 10 of the present invention, especially desirable results have been obtained wherein the flexible foam substrate is produced from a polyethylene having the pore density, pore size and surface area described above.

The binder employed in the construction of the flexible reticulated foam fluid treatment media 10 can be any binder compatible with the flexible foam substrate, the particles embedded in the binder/flexible foam substrate, and the flexible reticulated foam fluid treatment media 10 and which is capable of being cured at room or ambient temperatures. Examples of such binders include, but are not limited to, acrylic glue, polychloroprene cement, neoprene rubber cement, polychlorinated rubber adhesive, phenolic resin, resorcinol glue, phthalate ester adhesive, silicon glue, and polyurethane glue.

As previously stated, the particles applied to the coated substrate can be metal particles, metal oxide particles, activated carbon particles and mixtures thereof. The particles of the flexible reticulated foam fluid treatment media 10 can be selected from a variety of materials including but not limited to, brass, bronze, copper, zinc, iron, iron oxide, silver, tin, nickel, nickel oxide, aluminum, alumina, platinum, palladium rhodium ruthenium, titanium, titania, manganese, manganese oxide and antimony. These particles can be used individually or combined together to form the metal coating. Desirable results have been obtained where metal particles are bimetallic mixtures containing copper and zinc and trimetallic mixtures containing copper, zinc and silver.

The activated carbon particles employed in the practice of the present invention can be selected from any source of highly porous carbon, such as that derived from coal, pitch, coconut shells, corn husks, polyacrylonitrile (PAN) polymers, charred cellulosic fibers and wood. When utilizing activate carbon as at least one of the particles, the amount of activated carbon present on the flexible foam substrate can vary widely but will generally be from about 5 to about 45 weight percent.

The size and amount of the particles employed in the construction of the flexible reticulated foam fluid treatment media 10 can vary and will be dependent to a large extent on the fluid to be treated, as well as the flow rate of the fluid through the flexible reticulated foam fluid treatment media 10. The amount of particles present on the flexible reticulated foam substrate will desirably range from about 10 to 65 weight percent based on the weight of the flexible reticulated foam fluid treatment media 10 and the average size of the particles range of the particles present on the flexible reticulated foam substrate will desirably range from about 10 to about 400 mesh, based on U.S. standard screen sizes, and more desirably from about 180 to 220 mesh.

The flexible, reticulated foam fluid treatment media 10 which can be used in combination with a filter cartridge in accordance with the present invention is described in U.S. patent application Ser. No. 11/351,930, entitled “Flexible Reticulated Foam Fluid Treatment Media and Method of Preparation”, filed Feb. 10, 2006, the disclosure of which is hereby expressly incorporated herein in its entirety by reference.

As previously stated, a rigid reticulated foam fluid treatment media can be used, either per se or in combination with the flexible fluid treatment media, with a filter cartridge to remove various types of contaminants from a variety of fluids. The rigid reticulated foam structured fluid treatment media includes metal particles bound together in an interconnected form of a porous metal, sponge-like structure wherein one (1) cubic inch of the porous metal, sponge-like structure has at least about 325 square inches of surface area.

The metal particles employed in the rigid reticulated foam structured fluid treatment media can vary widely and will be dependant to a large extent on the type of contaminants to be removed by treatment of a fluid. Examples of the metal particles which can be used in the construction of the rigid reticulated foam fluid treatment media are described in U.S. Pat. No. 5,135,654, titled “Method for Treating Fluids” issued to Heskett, Aug. 4, 1992, and U.S. Pat. No. 4,642,192 titled “Method of Treating Fluids” issued to Heskett, Feb. 10, 1987, and U.S. Pat. No. 5,122,274, titled “Method of Treating Fluids” issued to Heskett, Jun. 16, 1992, the disclosures of each of which are hereby expressly incorporated herein in their entirety by reference. However, desirable results have been obtained wherein the metal particles are bimetallic mixtures containing copper and zinc, or trimetallic mixtures containing copper, zinc and silver.

The metal particles employed in the preparation of the rigid reticulated foam structured fluid treatment media element can be particles of a copper/zinc alloy commercially available from Fluid Treatment, Inc. of Constantine, Mich. and sold under their mark KDF. More particularly, particles of a copper/zinc alloy sold by this company and identified by the mark KDF-55 have been found useful in forming the rigid reticulated foam structured fluid treatment media. The commercially available metal particles described before are in a powder-like form having an average mesh size of about 200 mesh, based on U.S. Standard screen sizes.

To form the rigid reticulated foam structured fluid treatment media which has a sponge-like structure, wherein one (1) cubic inch of the rigid reticulated foam structured fluid treatment media has a surface area of about 325 square inches or more, polyethylene foam is cut to form a substrate having a desired size and shape. The polyethylene substrate is then submerged into a solvent for a period of time effective to provide the polyethylene substrate with a tacky surface. Copper powder is then mixed with a binder to form a slurry and the slurry is applied to the polyethylene substrate. The tacky surface of the polyethylene insures that a substantially uniform coating of the slurry containing copper powder sticks to the surface of the polyethylene substrate.

The slurry coated polyethylene substrate is allowed to dry under ambient conditions and then placed in a furnace maintained at from about 1950° F. to about 2150° F. for a period of time effective to evaporate the polyethylene substrate and produce a foam structure consisting of copper. During the heating of the slurry coated polyethylene substrate the furnace is flooded with hydrogen gas.

A 200 mesh powder consisting of metal particles (KDF-55) is admixed with a binder to form a slurry and the slurry is applied to the foam structure of copper. The slurry coated foam structure is allowed to dry under ambient conditions and the resulting hardened structure is then placed in a furnace flooded with hydrogen gas and maintained at from about 1950° F. to about 2150° F. for a period of time effective to sinter the copper/zinc alloy and to insure that any trace amounts of foreign material, such as binder and polyethylene, have been gassed off. After the sintering of the copper/zinc alloy has been completed and the impurities have been gassed off, the rigid reticulated foam structured fluid treatment media so produced is then removed from the furnace and allowed to slowly cool to ambient temperature. The rigid reticulated foam structured fluid treatment media so produced has a sponge-like structure wherein one (1) cubic inch of the reticulated foam structured fluid treatment media has a surface area of about 350 square inches.

The particles employed in the formulation of either the flexible reticulated foam fluid treatment media or the rigid reticulated foam fluid treatment media employed in the practice of the present invention can be selected from a variety of materials including but not limited to brass, bronze, copper, zinc, iron, iron oxide, silver, tin, nickel, nickel oxide, aluminum, alumina, platinum, palladium, rhodium, ruthenium, titanium, titania, manganese, manganese oxide and antimony. These particles can be used individually or combined together to form the metal coating. The preferred metal coating is formed from bimetallic and trimetallic mixtures containing copper and zinc and which are commercially available from Fluid Treatment, Inc. of Constantine, Mich. and so under their mark KDF. More particularly, particles of a copper/zinc alloy sold by Fluid Treatment, Inc. and identified by the mark KDF/55 have been found useful informing the flexible reticulated foam fluid treatment media and the rigid reticulated foam fluid treatment media used in the practice of the present invention. Further, in certain instances it has been found desirable to incorporate a mixture of particles which contain copper/zinc alloy and silver.

The metal particles employed in the fabrication of the rigid reticulated foam fluid treatment media are desirably in a powder-like form having an average mesh size of about 200 mesh, based on U.S. standard screen sizes. To form the rigid reticulated foam fluid treatment media, one cubic inch of the rigid reticulated foam fluid treatment media has a surface area of about 325 square inches or more.

The rigid reticulated foam fluid treatment media which can be used in combination with a filter cartridge, either per se or in combination with the flexible reticulated foam fluid treatment media and the method of making such rigid reticulated foam fluid treatment media, is disclosed in U.S. Pat. No. 5,599,456, entitled “Fluid Treatment Utilizing a Reticulated Foam Structured Media Consisting of Metal Particles” issued to Chris E. Fanning, Feb. 4, 1997, the disclosure of which is hereby expressly incorporated herein in its entirety by reference.

From the above description of the flexible reticulated foam fluid treatment media and the rigid reticulated foam fluid treatment media it is readily apparent that the chemical nature of the particles used in the construction of such media can vary widely and the particular mixture of particles will depend on the intended use of the media. Further, it should be appreciated and understood that the fluid treatment media can be a combination of the flexible reticulated foam fluid treatment media and the rigid reticulated foam fluid treatment media.

Referring now to FIG. 2, a filter assembly 20 constructed in accordance with the present invention is shown disposed in a conventional spa 21 to purify or decontaminate the water being used in the spa 21 by removing various contaminants. It should be understood that although the spa 21 is shown utilizing the filter assembly 20, the filter assembly 20 is not limited to use with a spa, but may be used with a wide variety of apparatuses using fluid treatment devices in accordance with the present invention.

Broadly, the filter assembly 20 includes a filter housing 22, a filter cartridge 24, and the reticulated foam fluid media 10. The filter housing 22 is cylindrically shaped and has a proximal end 26, a distal end 28, and a filter chamber 30 extending longitudinally through the filter housing 22 from the proximal end 26 to the distal end 28. Although the filter housing 22 is shown herein to have a substantially cylindrical shape, it will be appreciated that the filter housing 22 may be constructed in a variety of different shapes so long as the filter assembly 20 can accommodate at least one filter cartridge 24 and the reticulated foam fluid media 10 and function in accordance with the present invention. Suitable materials for construction of the filter housing 22 include metals such as aluminum, steel, titanium, magnesium or alloys containing these metals, polymeric materials, and composite materials which are capable of providing the desired strength and durability for the filter housing 22.

A support member 32 is disposed at the distal end 28 of the filter housing 22 to stabilize the filter cartridge 24 in the desired position within the filter housing 22. The filter housing 22 has a sidewall 34 which cooperates with support member 32 and a portion of the spa 21 to define the filter chamber 30, an inlet 36 and an outlet 38 which are in fluid communication with the filter chamber 30. The inlet 36 is shown formed in the support member 32 of the filter housing 22; and the outlet 38 is formed in the proximal end 26 of the filter housing 22. It should be understood that the inlet 36 and an outlet 38 may be formed in a variety of positions in the filter housing 22 so long as the inlet 36 and the outlet 38 are in fluid communication with the filter chamber and function in accordance with the present invention.

The proximal end 26 of the filter housing 22 is adapted to threadingly engage a sidewall 39 of the spa 21. The proximal end 26 of the filter housing 22 may be provided with an annular groove for receiving a seal member, such as an o-ring, to effect a fluid-tight seal between the filter housing 22 and the spa 21.

The filter cartridge 24 is disposed in the chamber 30 of the filter housing 22. The filter cartridge 24 is shown as cylindrically shaped, however, the filter cartridge 24 may be constructed in a variety of different shapes so long as the filter cartridge 24 functions in accordance with the present invention. Suitable materials for construction of the filter cartridge may be fibrous, pleated fabric, paper, wound polymeric fiber, such as propylene, micro fiberglass, cellulose, or combinations thereof. The filter cartridge 24 has a proximal end 40, a distal end 42 and an interior chamber or flow passageway 44 centrally positioned within the filter cartridge 24 extending from the proximal end 40 to the distal end 42 for receiving the fluid and the reticulated foam fluid treatment media 10. The flow passageway 44 has an inlet 46, an outlet 48, and a sidewall 50.

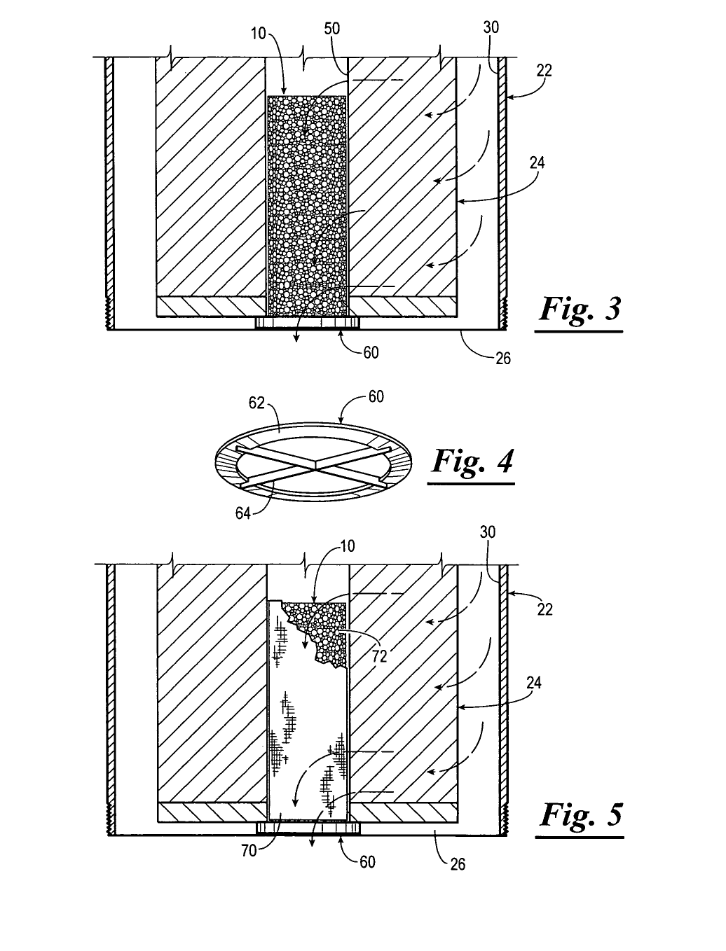

In some situations, the opening of the outlet of the spa or other such apparatus may be larger than the diameter of the reticulated foam fluid treatment media 10 such that the reticulated foam fluid treatment media 10 to fall into the opening, resulting in a clogged opening or damage to the spa. In such cases, as shown in FIGS. 3-5, a cartridge retainer 60 is provided so as to prevent the reticulated foam fluid treatment media 10 from falling into the outlet. The cartridge retainer 60 includes a o-shaped ring 62 having support members 64 extending across the o-shaped ring 62 for engaging a lower portion of the reticulated foam fluid treatment media 10 to stabilize the reticulated foam fluid treatment media 10 in the flow passageway 44 of the filter cartridge 24.

However, it should be understood that the reticulated foam fluid media 10 may be sized to frictionally engage the sidewall 50 of the flow passageway 44 of the filter cartridge 24. Further, referring to FIG. 5, packing cloth 70 may be wrapped about an outer wall 72 of the reticulated foam fluid treatment media 10 to frictionally stabilize the reticulated foam fluid treatment media 10 within the flow passageway 44 of the filter cartridge 24.

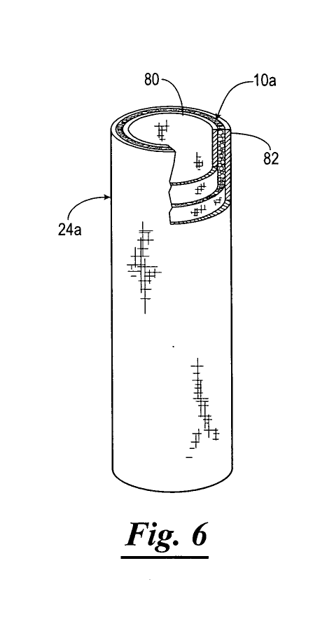

Referring to FIG. 6, a filter cartridge 24a is shown having the reticulated foam fluid treatment media section 10a embedded therein. The filter cartridge 24a, which is useful in treating fluids, can be partially fabricated of a fibrous material, paper and combinations thereof. The filter cartridge 24a is fabricated similar to commercially available fluid treatment cartridges, except that a section of the filter cartridge 24a, either the flexible or rigid reticulated foam fluid treatment media as hereinbefore described is, is embedded in the filter cartridge 24a. That is, the filter cartridge 24a is provided with an inner layer 80 and an outer layer 82 of the conventional filter cartridge material and the flexible or rigid reticulated foam fluid treatment media is sandwiched between the inner layer 80 and the outer layer 82 of the conventional filter cartridge material.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed.

What is claimed is:

1. A filter assembly operably connected to a supporting structure, the filter assembly removing contaminants from a fluid, the filter assembly comprising:
a filter housing having an inlet, an outlet and a chamber extending through the filter housing;
a filter cartridge positioned in the chamber of the filter housing, the filter cartridge constructed from a fibrous material used to filter contaminants from a fluid, the filter cartridge having a passageway extending from a proximal end of the filter cartridge to a distal end of the filter cartridge; and
a reticulated foam fluid treatment media disposed within a portion of the passageway of the filter cartridge.

2. The filter assembly of claim 1 wherein the reticulated foam fluid treatment media is a substantially flexible reticulated foam fluid treatment media.

3. The filter assembly of claim 1 wherein the reticulated foam fluid treatment media is a substantially rigid reticulated foam fluid treatment media.

4. The filter assembly of claim 1 wherein the filter housing has a cartridge retainer disposed adjacent the outlet of the housing for stabilizing the reticulated foam fluid treatment media within the passageway of the filter cartridge.

5. The filter assembly of claim 1 wherein a piece of fluid permeable material is disposed about at least a portion of the reticulated foam fluid treatment media to stabilize the reticulated foam fluid treatment media within the passageway of the filter cartridge.

6. The filter assembly of claim 1 wherein the reticulated foam fluid treatment media is a substantially flexible reticulated foam fluid treatment media and wherein the substantially flexible reticulated foam fluid treatment media comprises:
a flexible porous polymeric substrate;
a binder compatible with the flexible porous polymeric substrate, the binder disposed on the flexible porous polymeric substrate to provide a layer of binder on the flexible porous polymeric substrate; and
particles secured to the flexible porous polymeric substrate via the binder, the particles adapted to substantially remove selected contaminants from fluids contacted with the flexible reticulated foam fluid treatment media.

7. The filter assembly of claim 1 wherein the reticulated foam fluid treatment media is a substantially rigid reticulated foam fluid treatment media and wherein the substantially rigid reticulated foam fluid treatment media comprises:
a foamed copper substrate having particles of a copper/zinc alloy bound thereon in an interconnected form and capable of promoting a reduction/oxidation reaction between the contaminants and the substantially rigid reticulated foam fluid treatment media, and wherein one cubic inch of the substantially rigid reticulated foam fluid treatment media has a surface area of at least about 350 square inches.

8. A filter assembly operably connected to a supporting structure, the filter assembly removing contaminants from a fluid, the filter assembly comprising:
a filter housing having an inlet, an outlet and a chamber extending through the filter housing;
a filter cartridge positioned in the chamber of the filter housing, the filter cartridge constructed from a fibrous material used to filter contaminants from a fluid, the filter cartridge having a passageway extending from a proximal end of the filter cartridge to a distal end of the filter cartridge; and
a reticulated foam fluid treatment media embedded within the filter cartridge.

9. The filter assembly of claim 8 wherein the reticulated foam fluid treatment media is a substantially flexible reticulated foam fluid treatment media.

10. The filter assembly of claim 8 wherein the reticulated foam fluid treatment media is a substantially rigid reticulated foam fluid treatment media.

11. The filter assembly of claim 8 wherein the reticulated foam fluid treatment media is a substantially flexible reticulated foam fluid treatment media and wherein the substantially flexible reticulated foam fluid treatment media comprises:
a flexible porous polymeric substrate;
a binder compatible with the flexible porous polymeric substrate, the binder disposed on the flexible porous polymeric substrate to provide a layer of binder on the flexible porous polymeric substrate; and
particles secured to the flexible porous polymeric substrate via the binder, the particles adapted to substantially remove selected contaminants from fluids contacted with the substantially flexible reticulated foam fluid treatment media.

12. The filter assembly of claim 8 wherein the reticulated foam fluid treatment media is a substantially rigid reticulated foam fluid treatment media and wherein the substantially rigid reticulated foam fluid treatment media comprises:
a foamed copper substrate having particles of a copper/zinc alloy bound thereon in an interconnected form and capable of promoting a reduction/oxidation reaction between the contaminants and the reticulated foam structured fluid treatment elements, and wherein one cubic inch of the reticulated foam structured fluid treatment element has a surface area of at least about 350 square inches.
